(19) United States
(12) Patent Application Publication
(10) Pub. No.: US 2023/0032646 A1
(43) Pub. Date: Feb. 2, 2023

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventor: Osamu DAIDO, Tokyo (JP)

(73) Assignee: NEC Corporation, Minato-ku, Tokyo (JP)

(21) Appl. No.: 17/791,369

(22) PCT Filed: Jan. 22, 2020
(86) PCT No.: PCT/JP2020/002174

§ 371 Date: Jul. 7, 2022

(51) Int. Cl. G06N 5/04

(52) U.S. Cl. CPC G06N 5/04

(57) ABSTRACT

In the information processing apparatus, an acquisition unit acquires an input data matrix including a plurality of data rows each including a plurality of feature amounts. A division unit generates grouping information by dividing at least a portion of row numbers of the input data matrix in association with a child node selected based on a result of a condition determination at a condition determination node, and passes the grouping information to the child node. A rearrangement process unit performs a condition determination process of the plurality of data rows indicated in the received grouping information by a parallel process at the condition determination node. An output unit outputs predicted values corresponding to the plurality of data rows indicated in the received grouping information at the leaf node.

### TECHNICAL FIELD

The present disclosure relates to an inference process using a decision tree.

### BACKGROUND ART

Recently, it is required to process a large amount of data at high speed. One of methods for speeding up a data process is parallelization of a process. For example, a repetitive process, which operates a plurality of sets of data independently, can be expanded to multiple processes to be processed in parallel. As a system of a parallel process, a SIMD (Single Instruction Multiple Data) method has been known. The SIMD method is a parallel process method that speeds up processing by executing one instruction simultaneously on a plurality of sets of data. As a processor for the SIMD method, a vector processor, a GPU (Graphics Processing Unit), or the like is considered.

Patent Document 1 describes a technique in which a parallel process is applied to an inference using a decision tree. In Patent Document 1, identification information of each node of the decision tree and a condition determination result are expressed in binary numbers so that respective condition determinations for layers can be processed collectively.

### PRECEDING TECHNICAL REFERENCES

### Patent Document

Patent Document 1: Japanese Laid-open Patent Publication No. 2013-117862

### SUMMARY

### Problem to be Solved by the Invention

However, in the technique of Patent Document 1, since it executes all condition determination nodes are processed using all sets of data, a process is not efficiently conducted.

It is one object of the present disclosure to speed up the inference process using the decision tree by a parallel process.

### Means for Solving the Problem

According to an example aspect of the present disclosure, there is provided an information processing apparatus using a decision tree including condition determination nodes and leaf nodes, the information processing apparatus including:

an acquisition unit configured to acquire an input data matrix that includes a plurality of data rows each having a plurality of feature amounts;

a division unit configured to generate grouping information by dividing at least a portion of row numbers of the input data matrix in association with a child node selected based on a condition determination at the condition determination node, and pass the grouping information to the child node;

a parallel process unit configured to perform a determination decision process with respect to a plurality of rows indicated in the grouping information received at the condition determination node; and

an output unit configured to output respective predicted values for the plurality of data rows indicated in the grouping information received at the leaf node.

According to another example aspect of the present disclosure, there is provided an information processing method using a decision tree including condition determination nodes and leaf nodes, the information processing method including:

acquiring an input data matrix that includes a plurality of data rows each having a plurality of feature amounts;

generating grouping information by dividing at least a portion of row numbers of the input data matrix in association with a child node selected based on a condition determination at the condition determination node, and passing the grouping information to the child node;

performing a determination decision process with respect to a plurality of rows indicated by the grouping information received at the condition determination node; and

outputting respective predicted values for the plurality of data rows indicated by the grouping information received at the leaf node.

According to still another example aspect of the present disclosure, there is provided a recording medium storing a program, the program causing a computer to perform an information process using a decision tree including condition determination nodes and leaf nodes, the information process including:

acquiring an input data matrix that includes a plurality of data rows each having a plurality of feature amounts;

generating grouping information by dividing at least a portion of row numbers of the input data matrix in association with a child node selected based on a condition determination at the condition determination node, and passing the grouping information to the child node;

performing a determination decision process with respect to a plurality of rows indicated by the grouping information received at the condition determination node; and

outputting respective predicted values for the plurality of data rows indicated by the grouping information received at the leaf node.

### Effect of the Invention

According to the present disclosure, it is possible to speed up an inference process using a decision tree by a parallel process.

### BRIEF DESCRIPTION OF THE DRAWINGS

FIG. 1 is a block diagram illustrating a configuration of an information processing apparatus according to a first example embodiment.

FIG. 2 illustrates an example of a decision tree inference.

FIG. 3 schematically illustrates a division process of input data according to the first example embodiment.

FIG. 4 illustrates an example of a data division.

FIG. 5 is a block diagram illustrating a hardware configuration of an information processing apparatus.

FIG. 6 is a block diagram illustrating a functional configuration of an information processing apparatus.

FIG. 7 is a flowchart of a condition determination process.

FIG. 8 is a flowchart of a rearrangement process.

FIG. 9 schematically illustrates a division process of a row number group of input data according to a second example embodiment.

FIG. 10 illustrates a division example of the row number group.

FIG. 11 is a block diagram illustrating a functional configuration of an information processing apparatus according to a second example embodiment.

FIG. 12 is a block diagram illustrating a functional configuration of an information processing apparatus according to a third example embodiment.

### EXAMPLE EMBODIMENTS

In the following, example embodiments will be described with reference to the accompanying drawings.

### First Example Embodiment

(Basic Configuration)

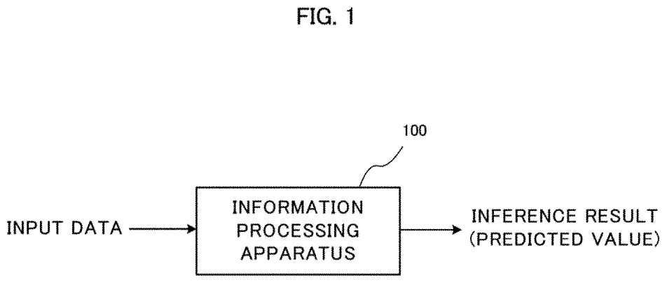

FIG. 1 illustrates a configuration of an information processing apparatus according to a first example embodiment of the present disclosure. An information processing apparatus 100 performs an inference using a decision tree model (hereinafter, referred to as a “decision tree inference”). Specifically, the information processing apparatus 100 performs a decision tree inference using input data, and outputs a predicted value for the input data as an inference result. Here, the information processing apparatus 100 executes a part of a process of the decision tree inference by a parallel process to speed up the process. Note that the parallel process is also referred to as “vectorization”.

(Explanation of Principle)

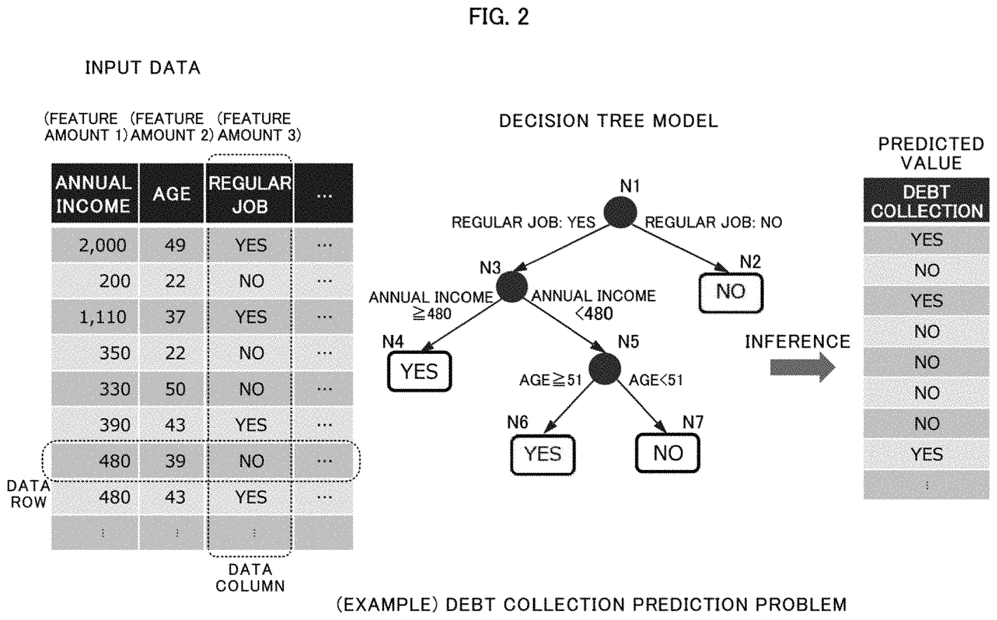

FIG. 2 illustrates an example of the decision tree inference. This example is regarded as a prediction problem of a debt collection in which pieces of attribute information for a large number of debtors are made to be input data and the decision tree model is used to infer an availability of the debt collection. As illustrated, the input data includes “annual income (feature amount 1)”, “age (feature amount 2)”, and “regular job (feature amount 3)” as feature amounts for each debtor. The decision tree model uses these sets of input data to predict the availability of the debt collection for each debtor.

The decision tree model in FIG. 2 is formed by nodes N1 through N7. The node N1 is a root node, and nodes N2, N4, N6, and N7 are leaf nodes. The nodes N1, N3, and N5 are condition determination nodes.

First, at the root node N1, it is determined whether or not the debtor has a regular job. When the debtor does not have the regular job, the process advances to the leaf node N2, and the debt collection is predicted to be impossible (NO). On the other hand, when the debtor has the regular job, the process advances to the condition determination node N3, and it is determined whether the annual income of the debtor is 4.8 million yen or more. When the annual income of the debtor is 4.8 million yen or more, the process advances to the leaf node N4, and it is predicted that the debt collection is possible (YES). When the annual income of the debtor is less than 4.8 million yen, the process advances to the condition determination node N5, and it is determined whether the age of the debtor is 51 years old or older. When the age of the debtor is 51 years old or older, the process advances to the leaf node N6, and the debt collection is predicted to be possible (YES). On the other hand, when the age of the debtor is less than 51 years old, the process advances to the leaf node N7, and the debt collection is predicted to be impossible (NO). Accordingly, the availability of the debt collection with respect to each debtor is output as a predicted value.

Now, in a case of applying the parallel process to the decision tree inference, it becomes a problem which portion is processed in parallel. First, a method for processing data rows of the input data in parallel can be considered; however, the decision tree model is not appropriate because the decision tree model does not use all feature amounts in a row at once. On the other hand, a method for processing data columns of the input data in parallel is also conceivable. However, the decision tree model does not necessarily perform a comparison process of the same instruction by a feature amount of the same data column with respect to all data rows of the input data. Therefore, in the present example embodiment, for each condition determination node, only the data rows, which execute the comparison process of the same instruction by the feature amount of the same data column, are collected as divisional data, and a plurality of data rows included in the divisional data are processed in parallel. Accordingly, only one node is considered in a single operation. Moreover, what kind of the comparison process is carried out is determined to one, and the feature amount used for the comparison process is also determined to one. As a result, vectorization becomes possible, and high speed becomes possible. Note that the divisional data corresponds to an example of grouping information in the present disclosure.

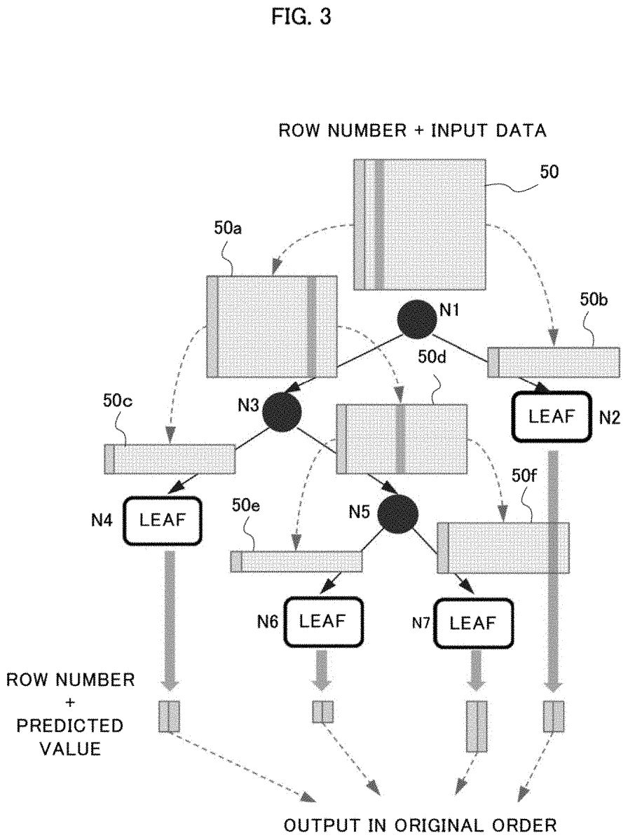

FIG. 3 schematically illustrates a division process of the input data according to the first example embodiment. Note that a configuration of the decision tree model is the same as that in FIG. 2, and it is assumed that a row number is assigned to each data row of input data 50. Since the root node N1 is the condition determination node, the information processing apparatus 100 divides the input data 50 into divisional data 50a to be transmitted to the child node N3 and divisional data 50b to be transmitted to the child node N2 based on a condition determination result of the root node N1. Specifically, in a case of assuming that a condition determination of the root node N1 uses a feature amount 3 in the input data 50, the information processing apparatus 100 generates the divisional data 50a corresponding to the child node N3 selected by the condition determination and the divisional data 50b corresponding to the child node N2 based on a condition determination command and a condition determination threshold value of the root node N1 and the feature amount 3. In this case, because the condition determination using the same column (feature amount 3) is conducted with respect to all row data included in the input data 50, it is possible for the information processing apparatus 100 to perform the condition determination by the parallel process.

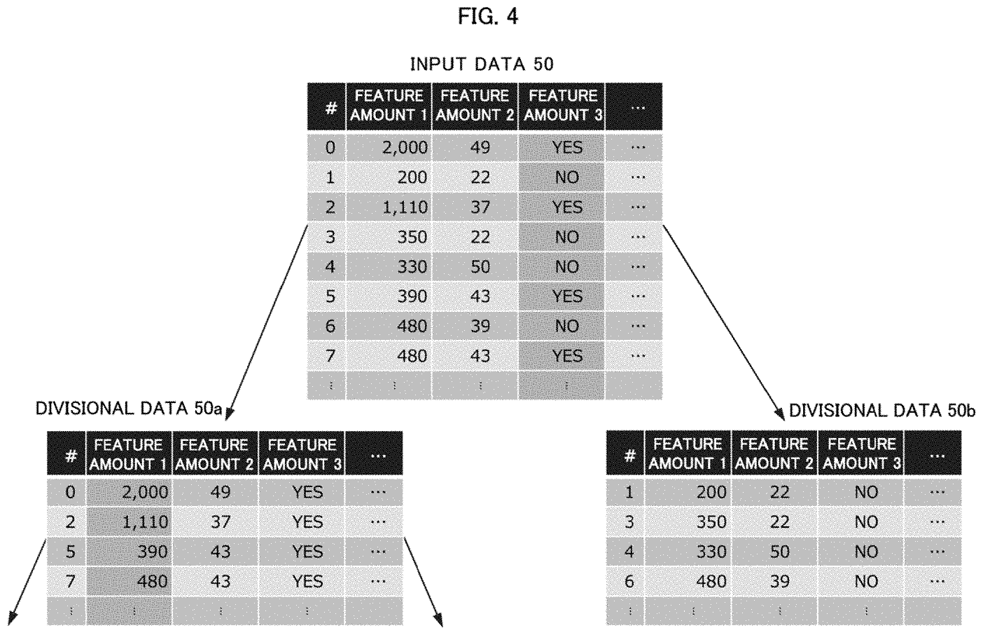

FIG. 4 illustrates an example of a data division. It is assumed that the input data 50 illustrated in FIG. 4 are input to the root node N1. The condition determination of the root node N1 is “feature amount 3=YES”. The information processing apparatus 100 divides the input data 50 based on the condition determination result of the root node N1. Specifically, the information processing apparatus 100 makes, as the divisional data 50a, a set of data rows (#0, #2, #5, #7, . . . ) in which the feature amount 3 indicates “YES” among the input data 50, and makes, as the divisional data 50b, a set of data rows (#1, #3, #4, #6, . . . ) in which the feature amount 3 indicates “NO”. The information processing apparatus 100 passes the divisional data 50a to the child node N3 and passes the divisional data 50b to the child node N2.

By this data division, only the row data to which the condition determination is conducted based on the same feature amount are provided to the child node N3 which is the condition determination node. Accordingly, at the child node N3, the condition determination with respect to the received divisional data 50a can be performed by the parallel process. That is, the information processing apparatus 100 can execute the condition determination using the feature amount 1 for all row data included in the divisional data 50a in parallel. Specifically, since the condition determination node N3 is regarded as the condition determination node for determining whether the feature amount 1 (annual income) is 4.8 million yen or more, the information processing apparatus 100 executes a determination as to whether or not the feature amount 1 indicates 4.8 million yen or more for all row data included in the divisional data 50a in parallel. Because the child node N2 is a leaf node, the information processing apparatus 100 outputs a predicted value corresponding to the leaf node N2 for all row data included in the divisional data 50b.

In an example of FIG. 3, at the condition determination node N3, the information processing apparatus 100 further divides the divisional data 50a into divisional data 50c and 50d, and passes the divisional data 50c and 50d to the leaf node N4 and the condition determination node N5, respectively. At the leaf node N4, the information processing apparatus 100 outputs a predicted value corresponding to the leaf node N4 with respect to all row data included in the divisional data 50c. At the condition determination node N5, the information processing apparatus 100 further divides the divisional data 50d into divisional data 50e and 50f based on the condition determination result, and passes the divisional data 50e and 50f to the leaf nodes N6 and N7, respectively. At the leaf node N6, the information processing apparatus 100 outputs a predicted value corresponding to the leaf node N6 with respect to all row data included in the divisional data 50e. Similarly, at the leaf node N7, the information processing apparatus 100 outputs a predicted value corresponding to the leaf node N7 with respect to all row data included in the divisional data 50f. Thus, when the predicted values are output from all leaf nodes, the information processing apparatus 100 outputs them as an inference result.

As described above, the information processing apparatus 100 divides data received at a condition determination node in association with child nodes selected according to a result of a condition determination, and passes divisional data to respective child nodes. Accordingly, it is possible for the information processing apparatus 100 to perform the parallel process with respect to the divisional data received from a parent node at each of the child nodes being the condition determination nodes, thereby speeding up the entire process.

(Hardware Configuration)

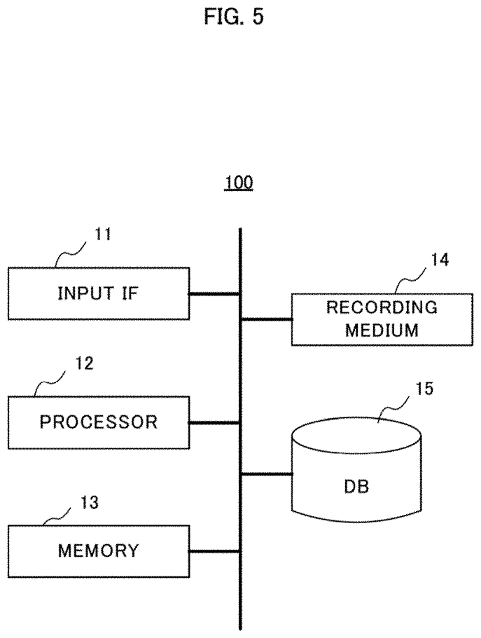

FIG. 5 is a block diagram illustrating a hardware configuration of the information processing apparatus 100. As illustrated, the information processing apparatus 100 includes an input IF (InterFace) 11, a processor 12, a memory 13, a recording medium 14, and a database (DB) 15.

The input IF 11 inputs and outputs data. Specifically, the input IF 11 acquires input data from an outside, and outputs an inference result generated by the information processing apparatus 100 based on the input data.

The processor 12 is a computer such as a CPU (Central Processing Unit) or a GPU (Graphics Processing Unit), and controls the entire information processing apparatus 100 by executing a program prepared in advance. In particular, the processor 12 performs the parallel process of data. A method to realize the parallel process is to use a SIMD processor such as the GPU. In a case where the information processing apparatus 100 performs the parallel process using the SIMD processor, the processor 12 may be used as the SIMD processor or the SIMD processor may be provided as a separate processor from the processor 12. Moreover, in the latter case, the information processing apparatus 100 causes the SIMD processor to execute operations capable of the parallel process, and causes the processor 12 to execute other operations.

The memory 13 is formed by a ROM (Read Only Memory), a RAM (Random Access Memory), or the like. The memory 13 stores various programs to be executed by the processor 12. The memory 13 is also used as a working memory during executions of various processes by the processor 12.

The recording medium 14 is a non-volatile and non-transitory recording medium such as a disk-shaped recording medium, a semiconductor memory, and is formed to be detachable from the information processing apparatus 100. The recording medium 14 records various programs executed by the processor 12.

The DB 15 stores data input from the input IF 11. Specifically, the input data acquired by the input IF 11 is stored in DB 15. Moreover, the DB 15 stores the decision tree model used for inference. Specifically, information representing a tree structure of a trained decision tree model and a node setting (a condition determination node setting and a leaf node setting) for each node are stored. The DB 15 corresponds to an example of a storage unit of the present disclosure.

(Functional Configuration)

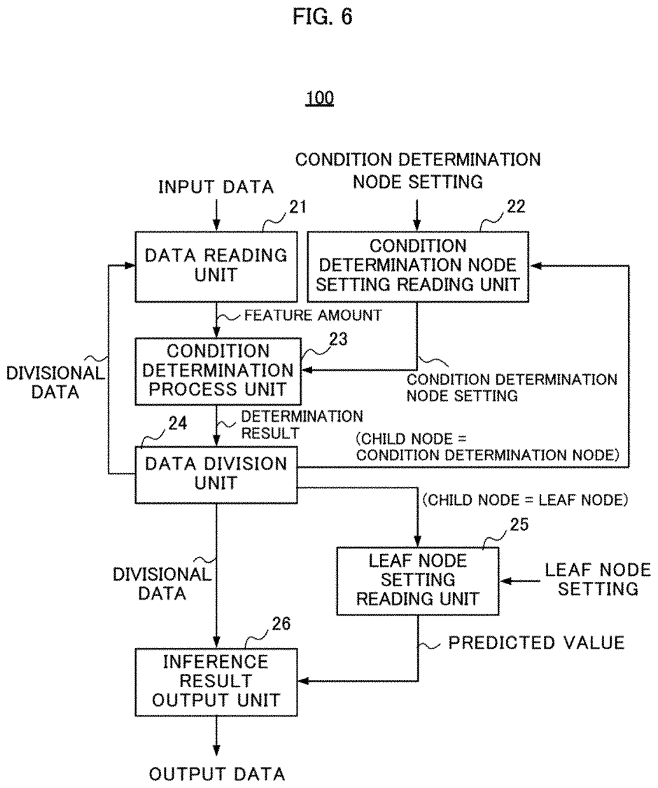

FIG. 6 is a block diagram illustrating a functional configuration of the information processing apparatus 100. The information processing apparatus 100 includes a data reading unit 21, a condition determination node setting reading unit 22, a condition determination process unit 23, a data division unit 24, a leaf node setting reading unit 25, and an inference result output unit 26.

The data reading unit 21 reads input data and stores the input data in a predetermined storage unit such as the DB 15. The input data correspond to a data matrix such as an example of FIG. 4, and includes a plurality of feature amounts associated with a plurality of row numbers. The data reading unit 21 corresponds to an example of an acquisition unit of the present disclosure.

The condition determination node setting reading unit 22 reads the condition determination node setting related to the condition determination node of the decision tree model to be used for inference, and outputs the condition determination node setting to the condition determination process unit 23. The condition determination node setting reading unit 22 initially reads the condition determination node setting related to the root node. Here, the “condition determination node setting” is setting information related to the condition determination executed in the condition determination node, and specifically includes a “feature amount”, a “condition determination threshold value”, and a “condition determination command”. The “feature amount” is regarded as a feature amount used for the condition determination, and refers to the “feature amount 1”, the “feature amount 2”, or the like of the input data illustrated in FIG. 4, for instance. The “condition determination threshold value” is regarded as a threshold value used for the condition determination. The “condition determination command” indicates a type of the condition determination; for instance, a match determination, or a comparison determination (a greater or smaller determination), or the like. The match determination corresponds to a determination as to whether or not the feature amount (regular job) matches the condition determination threshold value (YES) as “regular job: YES” in FIG. 2. Moreover, the comparison determination refers to determination of a relationship between the feature amount and the condition determination threshold value, such as “annual income 480” in FIG. 2.

The condition determination process unit 23 acquires a feature amount included in the condition determination node setting acquired from the condition determination node setting reading unit 22 from the input data stored in the storage unit. For instance, in a case of the decision tree model illustrated in FIG. 2, because the feature amount used for the condition determination of the root node N1 is “regular job (feature amount 3)”, the condition determination process unit 23 acquires the feature amount “regular job” for each data row from the input data stored in the storage unit. After that, the condition determination process unit 23 performs the condition determination using the feature amount, the condition determination command, and the condition determination threshold value. In an example of the decision tree model in FIG. 2, the condition determination process unit 23 determines “regular job (feature amount 3) =YES” or not for each data row of the input data, and sends the determination result to the data division unit 24. The condition determination process unit 23 is an example of a parallel process unit of the present disclosure.

The data division unit 24 divides the input data based on the determination result. Specifically, the data division unit 24 divides the input data in association with the child node selected in accordance with the determination result. Furthermore, in a case where child nodes of the condition determination node to be processed include the condition determination node, the data division unit 24 sends the divisional data to the data reading unit 21. Moreover, the data division unit 24 sends an instruction to the condition determination node setting reading unit 22, and the condition determination node setting reading unit 22 reads the condition determination node setting of the child node. After that, the condition determination process unit 23 performs the condition determination of the child node based on the divisional data and the condition determination node setting of the child node, and sends a determination result to the data division unit 24. Accordingly, in a case where the child nodes of the condition determination node to be processed include the condition determination node, the condition determination by the condition determination process unit 23 and the data division by the data division unit 24 are repeated for the condition determination node. The data division unit 24 is an example of a division unit of the present disclosure.

In a case where the child nodes of the condition determination node to be processed include the leaf node, the data division unit 24 sends the divisional data to the inference result output unit 26. In addition, the data division unit 24 sends an instruction to the leaf node setting reading unit 25, and the leaf node setting reading unit 25 reads the leaf node setting of the child node. The leaf node setting includes the predicted value of the leaf node. Note that in a case where the decision tree is a classification tree, the predicted value indicates a classification result, and in a case where the decision tree is a regression tree, the predicted value indicates a numerical value. Next, the leaf node setting reading unit 25 sends the read predicted value to the inference result output unit 26.

The inference result output unit 26 associates the divisional data received from the data division unit 24 with the predicted value received from the leaf node setting reading unit 25, and outputs an inference result. When the process is completed for all input data, predicted values for all row data of the input data are obtained. Note that the inference result output unit 26 may rearrange and output all obtained row data and the predicted values thereof in an order of the row number of the input data. The inference result output unit 26 is an example of an output unit of the present disclosure.

Now, it is assumed that the decision tree model illustrated in FIG. 2 is used to infer the input data 50 illustrated in FIG. 4. First, the input data 50 are read into the data reading unit 21, and the condition determination node setting of the root node N1 is read into the condition determination node setting reading unit 22. The condition determination process unit 23 performs a determination of “regular job (feature amount 3)=YES” based on the condition determination node setting, and sends a determination result to the data division unit 24. The data division unit 24 divides the input data 50 into the divisional data 50a and 50b based on the determination result as illustrated in FIG. 4.

Based on the determination result at the root node N1, the data division unit 24 sends the divisional data 50a to the data reading unit 21 and instructs the condition determination node setting reading unit 22 to read the condition determination node setting of the condition determination node N3 for the condition determination node N3 that is the child node of the root node N1. Next, the condition determination process unit 23 performs the condition determination based on the divisional data 50a and the condition determination node setting of the condition determination node N3, and outputs the determination result to the data division unit 24.

Moreover, the data division unit 24 sends the divisional data 50b to the inference result output unit 26 based on the determination result at the root node N1 for the leaf node N2 which is the child node of the root node N1, and instructs the leaf node setting reading unit 25 to read a leaf node setting of the leaf node N2. The leaf node setting reading unit 25 reads the leaf node setting of the leaf node N2, and sends a predicted value to the inference result output unit 26.

In the above-described manner, when the child node is the condition determination node, the condition determination is repeated using the condition determination node setting and the divisional data. On the other hand, when the child node is the leaf node, the predicted value of the leaf node is sent to the inference result output unit 26. When respective predicted values for all leaf nodes of the decision tree model are sent to the inference result output unit 26, the inference result output unit 26 outputs an inference result including the predicted values corresponding to all data rows included in the input data as output data.

(Flowchart)

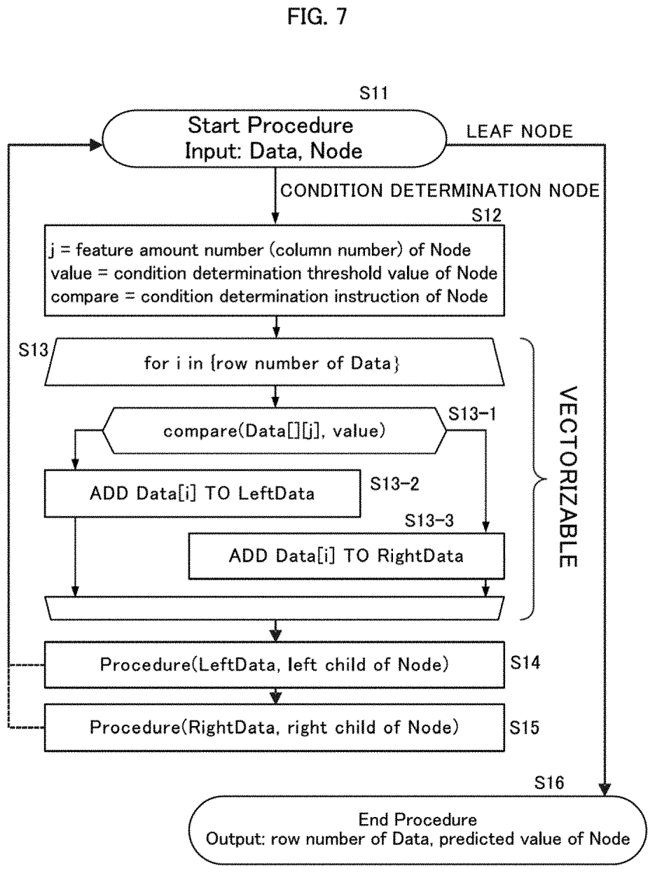

Next, flowcharts of processes performed by the information processing apparatus 100 will be described. FIG. 7 illustrates a flowchart of the condition determination process. The condition determination process corresponds to a process for inputting the input data to the decision tree model and outputting an inference result. This process can be implemented by the processor 12 illustrated in FIG. 5 executes a program prepared in advance.

First, in step S11, the data reading unit 21 reads input data Data, and the condition determination node setting reading unit 22 reads a node setting Node of a target node (initially, the root node). When the target node is the condition determination node, in step S12, the condition determination process unit 23 sets a feature amount number (column number) included in the condition determination node setting to a variable j, sets the condition determination threshold value to a variable ‘value’, and sets the condition determination command to a function ‘compare’. Next, the condition determination process unit 23 executes a loop process of step S13 for all rows of the input data Data.

In the loop process, in step S13-1, the condition determination process unit 23 compares the feature amount j for each data row of the input data Data by the function ‘compare’ with the condition determination threshold value (step S13-1). The data division unit 24 stores a data row regarded as a comparison result corresponding to a branch on a left side of the target node in divisional data LeftData in step S13-2, and stores a data row resulting in a comparison result corresponding to a branch on a right side of the target node in divisional data RightData in the step S13-3. The condition determination process unit 23 performs this process for all data rows of the input data Data, and terminates the loop process. This loop process is performed by the parallel process.

Next, in step S14, the divisional data LeftData are sent to the data reading unit 21, and the node setting of each child node corresponding to the divisional data LeftData is read. When the child node is the condition determination node, the condition determination node setting reading unit 22 reads the condition determination node setting in step S11, and steps S12 and S13 are executed on the condition determination node. On the other hand, when the child node is the leaf node, the leaf node setting reading unit 25 reads the leaf node setting in step S16, and sends a predicted value of the leaf node to the inference result output unit 26.

Similarly, in step S15, the divisional data RightData are sent to the data reading unit 21, and a node setting of a child node corresponding to the divisional data RightData is read. When the child node is the condition determination node, the condition determination node setting reading unit 22 reads the condition determination node setting in step S11, and steps S12 and S13 are executed on the condition determination node. On the other hand, when the child node is the leaf node, in step S16, the leaf node setting reading unit 25 reads the leaf node setting and sends a predicted value of the leaf node to the inference result output unit 26.

Accordingly, the information processing apparatus 100 advances the process to the child nodes in order from the root node of the decision tree model, and terminates the condition determination process when reaching all leaf nodes. Here, the loop process in step S13 can be executed by the processor 12 in the parallel process, so that a high-speed process can be performed even in a case where the input data includes a large number of data rows.

At the end of the condition determination process, predicted values for all data rows of the input data are obtained as an inference result. Although the inference result is temporarily stored in the storage unit in the information processing apparatus 100 such as the memory 13 or the DB 15 illustrated in FIG. 5, the inference result is basically stored in the storage unit in an order in which the predicted value is obtained, and is not necessarily aligned in the order of the row number of the input data. The inference result output unit 26 outputs the obtained inference result. In this case, the inference result output unit 26 may output the predicted values for all data rows, or may output only a specific predicted value. In addition, the predicted value may be output in an order stored in the storage unit, or may be output after performing the process for rearranging in an order of the row number in the input data (hereinafter, referred to as a “rearrangement process”).

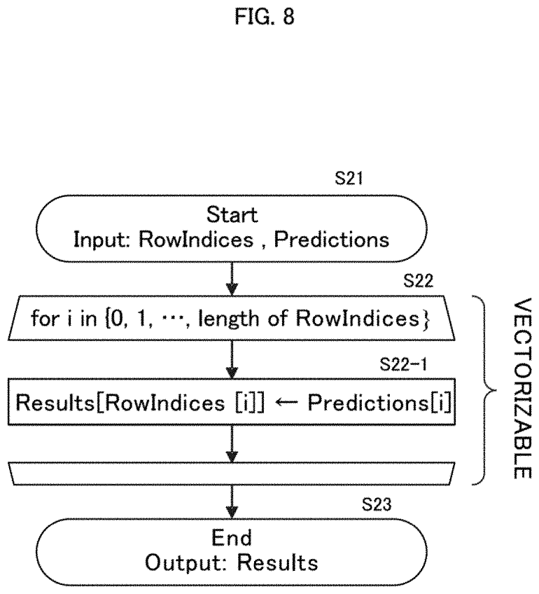

FIG. 8 is a flowchart of the rearrangement process. This process can be implemented by the processor 12 illustrated in FIG. 5, which executes a program prepared in advance. First, in step S21, the inference result output unit 26 acquires all row numbers included in the input data as RowIndices, and acquires predicted values as Predictions. Next, the inference result output unit 26 executes a loop process in step S22. Specifically, in step S22-1, the inference result output unit 26 stores the predicted value Predictions [i] in a matrix Results in an order of the row number RowIndices in the input data. Accordingly, in the matrix Results, the predicted values are rearranged in the order of the row number of the input data. The processor 12 may perform this loop process in parallel. Next, the inference result output unit 26 outputs the obtained matrix Results (step S26). The predicted values are then output in the order of the row number of the input data.

As described above, according to the first example embodiment, because the information processing apparatus 100 divides the input data into groups for performing the same condition determination using the same feature amount based on the result of the condition determination, and performs the parallel process for each divisional data, it is possible to speed up the overall process.

### Second Example Embodiment

In the first example embodiment, the input data are divided into groups for performing the same condition determination using the same feature amount based on a result of the condition determination. However, in the method of the first example embodiment, in a case where the input data are large, a processing load such as copying data increases. Therefore, in the second example embodiment, the input data itself are stored in a storage unit or the like without being divided, while only the row numbers of the input data are collected to form a row number group, which is divided and passed to each child node. That is, each row number of the input data is used as a pointer to the input data stored in the storage unit, and pointers are grouped to perform the parallel process. Note that the row number group is an example of grouping information of the present disclosure.

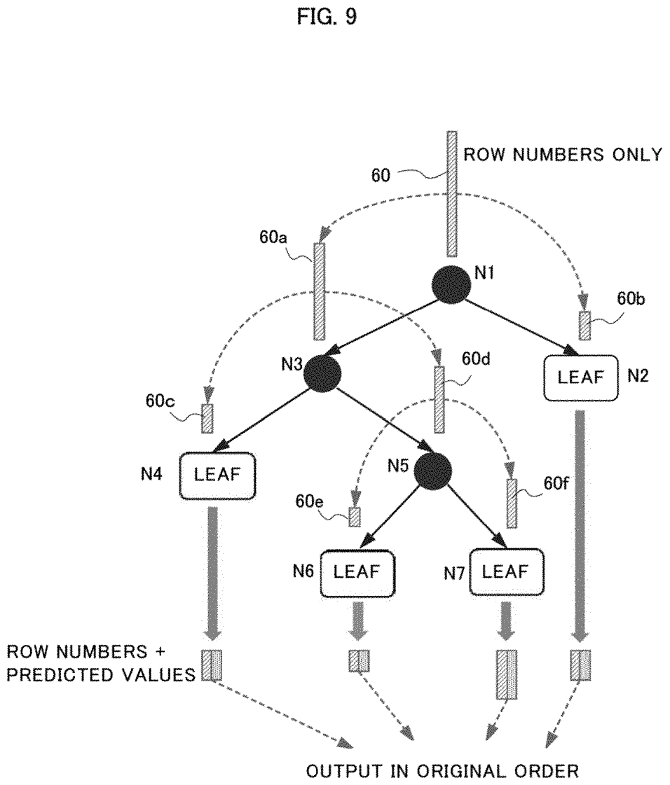

FIG. 9 schematically illustrates a row number division process of the input data according to the second example embodiment. Note that a configuration of the decision tree model is the same as that depicted in FIG. 2. First, an information processing apparatus 100x extracts a row number group 60 only from the input data. Actual input data are stored in a predetermined storage unit in the information processing apparatus 100x. Since the root node N1 is a condition determination node, the information processing apparatus 100x divides the row number group 60 into a row number group 60a passed to the child node N3 and a row number group 60b passed to the child node N2 based on the result of the condition determination of the condition determination node N1. At this time, the information processing apparatus 100x performs a process by referring to the input data stored in the storage unit based on the row number group 60. More specifically, since the condition determination of the root node N1 uses the feature amount 3 in the input data, the information processing apparatus 100x generates the row number groups 60a and 60b based on the condition determination command and the condition determination threshold value of the condition determination node N1 and the feature amount 3. In this case, since the information processing apparatus 100x performs a condition determination using the same column data (feature amount 3) on all row data included in the input data, it is possible to execute this process by the parallel process.

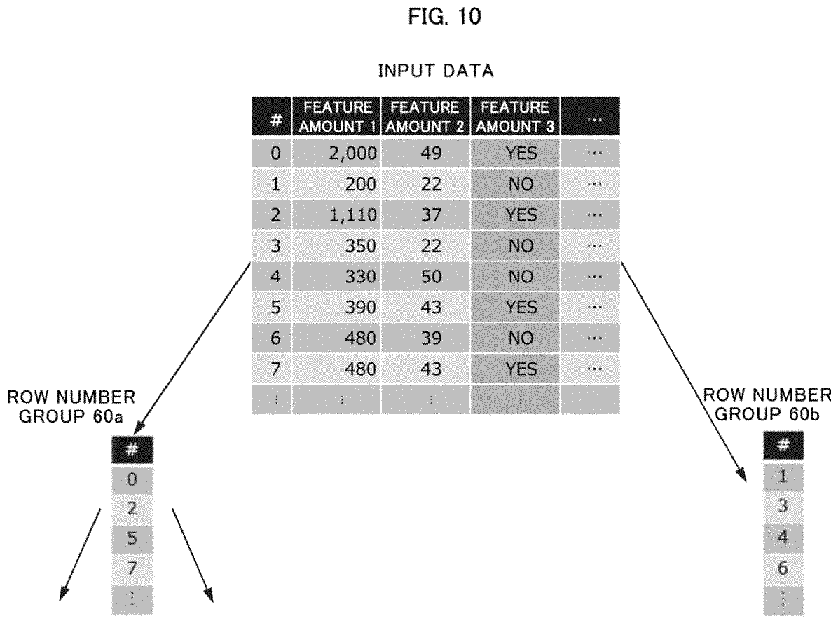

FIG. 10 illustrates a division example of the row number group. It is assumed that the input data illustrated in FIG. 10 are input to the root node N1. Because the condition determination of the root node N1 is “feature amount 3=YES”, the information processing apparatus 100x divides only the row numbers of the input data based on the condition determination result of the root node N1. More specifically, the information processing apparatus 100x creates, as the row number group 60a, a set of row numbers of data rows (#0, #2, #5, #7, . . . ) in which the feature amount 3 indicates “YES”, and passes the row number group 60a to the child node N3. In addition, the information processing apparatus 100x creates, as the row number group 60b, a set of the row numbers of the data rows (#1, #3, #4, #6, . . . ) in which the feature amount 3 indicates “NO”, and passes the row number group 60b to the child node N2.

Accordingly, only the row numbers of the row data, to which the condition determination is performed based on the same feature amount, are provided to the child node N3. Therefore, the child node N3, which is the condition determination node, needs to perform the condition determination with respect to only data rows corresponding to the received row number group 60a, so that this process can be performed by the parallel process. That is, the information processing apparatus 100x can execute the condition determination using the feature amount 1 in parallel for all row data corresponding to the row number group 60a. Note that since the child node N2 is the leaf node, the information processing apparatus 100x outputs a predicted value corresponding to the leaf node N2 for all row data corresponding to the row number group 60b.

Returning to FIG. 9, the information processing apparatus 100x refers to the input data based on the row number group 60a at the condition determination node N3, further divides the row number group 60a into row number groups 60c and 60d, and passes the row number groups 60c and 60d to the leaf node N4 and the condition determination node N5, respectively. At the leaf node N4, the information processing apparatus 100x outputs a predicted value corresponding to the leaf node N4 for all row data included in the row number group 60c. At the condition determination node N5, the information processing apparatus 100x further divides the row number group 60d into row number groups 60e and 60f based on the condition determination result, and passes the row number groups 60e and 60f to the leaf nodes N6 and N7, respectively. At the leaf node N6, the information processing apparatus 100x outputs a predicted value corresponding to the leaf node N6 for all row data included in the row number group 60e. Similarly, at the leaf node N7, the information processing apparatus 100x outputs a predicted value corresponding to the leaf node N7 for all row data included in the row number group 60f. In this manner, when the predicted values are output from all leaf nodes, the information processing apparatus 100x outputs the predicted values as an inference result.

As described above, in the second example embodiment, the information processing apparatus 100x divides the row number group based on the determination result in the condition determination node, and passes divisional groups to the child nodes, respectively. Therefore, the information processing apparatus 100x can perform the parallel process on the input data corresponding to the row number group received from a parent node at the child node which is the condition determination node, and it is possible to speed up the entire process.

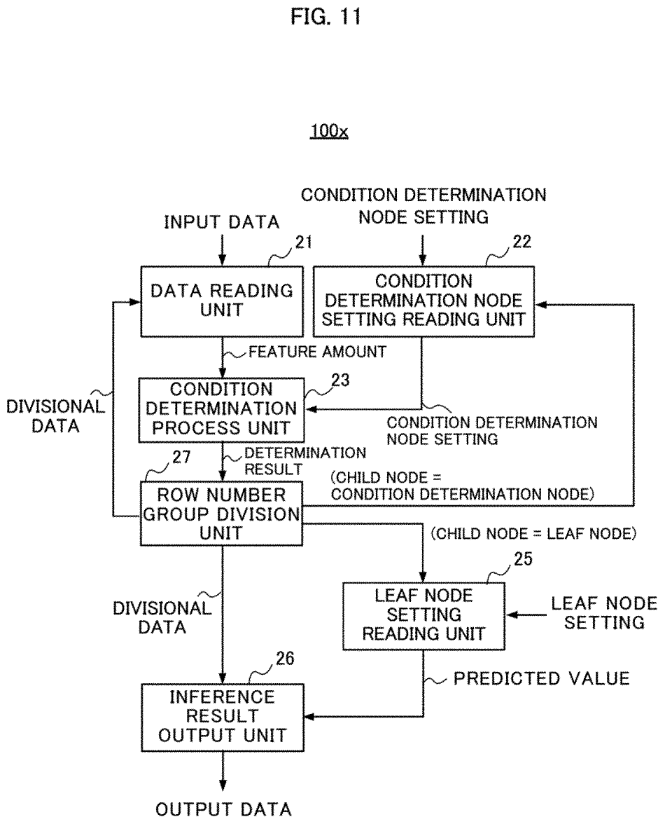

A hardware configuration of the information processing apparatus 100x according to the second example embodiment is the same as that depicted in FIG. 5. FIG. 11 is a block diagram illustrating a functional configuration of the information processing apparatus 100x according to the second example embodiment. The functional configuration of the information processing apparatus 100x is basically the same as that of the information processing apparatus 100 of the first example embodiment illustrated in FIG. 6. However, in the information processing apparatus 100x, a row number group division unit 27 divides the row number group of the input data, and sends divisional row number groups to the data reading unit 21 and the inference result output unit 26.

The condition determination process of the information processing apparatus 100x according to the second example embodiment is basically the same as the flowchart illustrated in FIG. 7. However, in steps S13-2 and S13-3, the information processing apparatus 100x stores only the row numbers in LeftData and RightData. In steps S14 and S15, the information processing apparatus 100x performs a process by referring to the input data stored in the storage unit based on the row number groups stored in LeftData and RightData.

### Third Example Embodiment

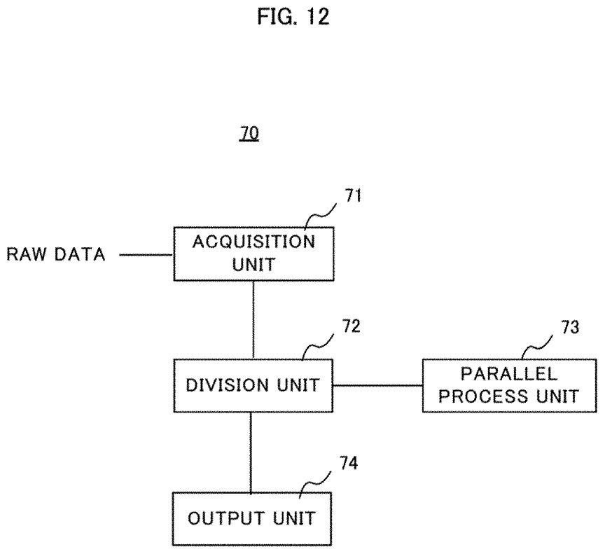

FIG. 12 is a block diagram illustrating a functional configuration of an information processing apparatus 70 according to a third example embodiment. The information processing apparatus 70 uses a decision tree having condition determination nodes and leaf nodes. The information processing apparatus 70 includes an acquisition unit 71, a division unit 72, a parallel process unit 73, and an output unit 74. The acquisition unit 71 acquires an input data matrix including a plurality of data rows each having a plurality of feature amounts. At the condition determination node, the division unit 72 generates grouping information by dividing at least a portion of the row numbers of the input data matrix in association with the child node selected according to a result of the condition determination, and passes the grouping information to the child node. The parallel process unit 73 performs a condition determination process of a plurality of data rows indicated in the received grouping information by parallel process at the condition determination node. The output unit 74 outputs predicted values corresponding to a plurality of data rows indicated by the received grouping information at the leaf node.

A part or all of the example embodiments described above may also be described as the following supplementary notes, but not limited thereto.

(Supplementary Note 1)

1. An information processing apparatus using a decision tree including condition determination nodes and leaf nodes, the information processing apparatus comprising:

an acquisition unit configured to acquire an input data matrix that includes a plurality of data rows each having a plurality of feature amounts;

a division unit configured to generate grouping information by dividing at least a portion of row numbers of the input data matrix in association with a child node selected based on a condition determination at the condition determination node, and pass the grouping information to the child node;

a parallel process unit configured to perform a determination decision process with respect to a plurality of rows indicated in the grouping information received at the condition determination node; and

an output unit configured to output respective predicted values for the plurality of data rows indicated in the grouping information received at the leaf node.

(Supplementary Note 2)

2. The information processing apparatus according to supplementary note 1, wherein the division unit generates divisional data matrixes acquired by dividing the input data matrix as the grouping information.

(Supplementary Note 3)

3. The information processing apparatus according to supplementary note 2, wherein the division unit generates row number groups by dividing only the portion of row numbers of the input data matrix as the grouping information.

(Supplementary Note 4)

4. The information processing apparatus according to supplementary note 3, further comprising a storage unit configured to store the input data matrix, wherein the parallel process unit performs a condition determination process by referring to the input data matrix stored in the storage unit based on row numbers included in each row number group.

(Supplementary Note 5)

5. The information processing apparatus according to any one of supplementary notes 1 through 4, wherein the output unit rearranges and outputs the predicted values in the same order as an order of the row numbers in the input data matrix.

(Supplementary Note 6)

6. The information processing apparatus according to supplementary note 5, wherein the output unit performs a rearrangement process for rearranging the predicted values in the same order as the order of the row numbers in the input data matrix, by a parallel process.

(Supplementary Note 7)

7. The information processing apparatus according to supplementary notes 1 through 6, wherein the parallel process unit performs a parallel process of a SIDM method.

(Supplementary Note 8)

8. The information processing apparatus according to supplementary notes 1 through 6, wherein

the condition determination node selects one child node from among a plurality of child nodes based on a result of the condition determination for performing a comparison and a computation by a predetermined instruction with respect to a value of a predetermined feature amount included in the input data matrix and a predetermined threshold value; and

the leaf node does not have a child node, and outputs a predicted value corresponding to the leaf node.

(Supplementary Note 9)

9. An information processing method using a decision tree including condition determination nodes and leaf nodes, the information processing method comprising:

acquiring an input data matrix that includes a plurality of data rows each having a plurality of feature amounts;

generating grouping information by dividing at least a portion of row numbers of the input data matrix in association with a child node selected based on a condition determination at the condition determination node, and passing the grouping information to the child node;

performing a determination decision process with respect to a plurality of rows indicated by the grouping information received at the condition determination node; and

outputting respective predicted values for the plurality of data rows indicated by the grouping information received at the leaf node.

(Supplementary Note 10)

10. A recording medium storing a program, the program causing a computer to perform an information process using a decision tree including condition determination nodes and leaf nodes, the information process comprising:

acquiring an input data matrix that includes a plurality of data rows each having a plurality of feature amounts;

generating grouping information by dividing at least a portion of row numbers of the input data matrix in association with a child node selected based on a condition determination at the condition determination node, and passing the grouping information to the child node;

performing a determination decision process with respect to a plurality of rows indicated by the grouping information received at the condition determination node; and

outputting respective predicted values for the plurality of data rows indicated by the grouping information received at the leaf node.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

21 Data reading unit

22 Condition determination node setting unit

23 Condition determination process unit

24 Data division unit

25 Leaf node setting reading unit

26 Inference result output unit

27 Row number group division unit

70, 100, 100x Information processing apparatus

What is claimed is:

1. An information processing apparatus using a decision tree including condition determination nodes and leaf nodes, the information processing apparatus comprising:
a memory storing instructions; and
one or more processors configured to execute the instructions to:
acquire an input data matrix that includes a plurality of data rows each having a plurality of feature amounts;
generate grouping information by dividing at least a portion of row numbers of the input data matrix in association with a child node selected based on a condition determination at the condition determination node, and pass the grouping information to the child node;
perform a determination decision process with respect to a plurality of rows indicated in the grouping information received at the condition determination node; and
output respective predicted values for the plurality of data rows indicated in the grouping information received at the leaf node.

2. The information processing apparatus according to claim 1, wherein the processor generates divisional data matrixes acquired by dividing the input data matrix as the grouping information.

3. The information processing apparatus according to claim 2, wherein the processor generates row number groups by dividing only the portion of row numbers of the input data matrix as the grouping information.

4. The information processing apparatus according to claim 3, wherein the processor is further configured to store the input data matrix in the memory, wherein
the processor performs a condition determination process by referring to the input data matrix stored in the memory based on row numbers included in each row number group.

5. The information processing apparatus according to claim 1, wherein the processor rearranges and outputs the predicted values in the same order as an order of the row numbers in the input data matrix.

6. The information processing apparatus according to claim 5, wherein the processor performs a rearrangement process for rearranging the predicted values in the same order as the order of the row numbers in the input data matrix, by a parallel process.

7. The information processing apparatus according to claim 1, wherein the processor performs a parallel process of a SIDM method.

8. The information processing apparatus according to claim 1, wherein
the condition determination node selects one child node from among a plurality of child nodes based on a result of the condition determination by a comparison and a computation of a predetermined instruction with respect to a value of a predetermined feature amount included in the input data matrix and a predetermined threshold value; and
the leaf node does not have a child node and outputs a predicted value corresponding to the leaf node.

9. An information processing method using a decision tree including condition determination nodes and leaf nodes, the information processing method comprising:
acquiring an input data matrix that includes a plurality of data rows each having a plurality of feature amounts;
generating grouping information by dividing at least a portion of row numbers of the input data matrix in association with a child node selected based on a condition determination at the condition determination node, and passing the grouping information to the child node;
performing a determination decision process with respect to a plurality of rows indicated by the grouping information received at the condition determination node; and
outputting respective predicted values for the plurality of data rows indicated by the grouping information received at the leaf node.

10. A non-transitory computer-readable recording medium storing a program, the program causing a computer to perform an information process using a decision tree including condition determination nodes and leaf nodes, the information process comprising:
acquiring an input data matrix that includes a plurality of data rows each having a plurality of feature amounts;
generating grouping information by dividing at least a portion of row numbers of the input data matrix in association with a child node selected based on a condition determination at the condition determination node, and passing the grouping information to the child node;
performing a determination decision process with respect to a plurality of rows indicated by the grouping information received at the condition determination node; and
outputting respective predicted values for the plurality of data rows indicated by the grouping information received at the leaf node.
